(19) United States
(12) Patent Application Publication
(10) Pub. No.: US 2025/0334051 A1
(43) Pub. Date: Oct. 30, 2025

(54) TURBINE ENGINE FOR AIRCRAFT WITH HEAT EXCHANGER

(71) Applicants: SAFRAN AERO BOOSTERS, Herstal (BE); GENERAL ELECTRIC COMPANY, Schenectady, NY (US)

(72) Inventor: Rémy Henri Pierre PRINCIVALLE, Herstal (BE)

(21) Appl. No.: 18/580,346

(22) PCT Filed: Jul. 21, 2021
(86) PCT No.: PCT/EP2021/070433

§ 371 Date: Jul. 3, 2024

(51) Int. Cl. F01D 5/14; F01D 9/02

(52) U.S. Cl. CPC F01D 5/147; F01D 9/02; F05D 2220/323

(57) ABSTRACT

Turbomachine (1) comprising an unducted propeller (14) propelling a tertiary flow (13), a fan (12) and a compressor (4) compressing a primary flow (F1), as well as an annular passage (19) for the flow of a secondary flow (F2) downstream of the fan (12); the annular passage (19) accommodating an annular row of rectifier vanes (22) and at least one heat exchanger (24) downstream of the row of vanes (22); a plurality of diffusion corridors being provided upstream of the at least one exchanger (24), each corridor being delimited circumferentially by an intrados and by an extrados of two circumferentially adjacent vanes (22), and by at least one fin carried by at least one of the two circumferentially adjacent vanes (22).

### TECHNICAL AREA

The invention relates to the architecture of a turbomachine for an aircraft and in particular to the cooling of oil in a turbomachine.

### PRIOR ART

A turbomachine generally includes a hydraulic circuit intended for the lubrication and/or cooling of certain mechanical components. To evacuate the heat stored by the oil, one or more heat exchangers are generally provided so that the cold air, available in quantity in the environment of the aircraft, exchanges heat with the oil. hot. The exchanger can be integrated into the air flow of the turbomachine, in the form of a radiator or it can be integrated into a blade as described in document FR 3 089 552.

The compactness of the motors on the one hand, and their rotational speed and their power on the other hand, may require larger heat exchangers in a radially smaller air stream. Unlike a small exchanger in a large air flow, proportionally larger heat exchangers in a smaller air flow generate pressure losses which are not negligible. This problem is found in engines comprising an unducted propeller and a reduction gear inserted between the low-pressure compressor and the propeller. The gearbox constitutes an additional element that must be cooled and therefore an additional need for heat exchange to cool the oil circulating in the gearbox.

One solution to minimizing the number of exchangers or their bulk in the air flow is to maximize their efficiency. This can be achieved by slowing down the air flow before entering the exchanger. Slowing down can be achieved by increasing the section of the air stream, which, at a constant flow rate, results in a reduction in the flow speed. A diffusive channel can thus be provided upstream of the exchanger.

However, this solution has its limits, because to obtain flow stability, it is necessary for the diffusive channel to be axially long enough, which therefore imposes a minimum axial length for the turbomachine. This solution is therefore incompatible with a compact architecture.

### PRESENTATION OF THE INVENTION

The problem that the present invention proposes to solve can be considered as the design of a turbomachine respecting both the constraint of the quantity of heat to be evacuated by the hydraulic circuit and the constraint of maximum axial dimension.

As such, the object of the invention relates to a turbomachine for an aircraft comprising: a compressor compressing a primary flow; a fan propelling a secondary flow; an annular passage for the flow of the secondary flow downstream of the fan; an unducted propeller propelling a tertiary flow, the primary, secondary and tertiary flows being distinct from each other; an annular row of guide vanes arranged in the passage, each vane having an intrados and an extrados; and at least one heat exchanger arranged in the passage downstream of the row of vanes; the turbomachine being remarkable in that it further comprises: a plurality of diffusion corridors upstream of the at least one exchanger, each corridor being delimited circumferentially by an intrados and by an extrados of two circumferentially adjacent vanes, and each corridor being delimited radially by at least one fin carried by at least one of the two circumferentially adjacent vanes.

Such a turbomachine makes it possible to slow down the air flow in a stable manner over a shorter axial distance, thus respecting both the axial bulk constraint and the need to cool a lot of oil.

The axial length necessary for the stability of flow diffusion depends essentially on the height of the channel. Thus by dividing the channel into corridors, we reduce the radial height of each of the air passages and we can therefore slow down the air flow in a stable manner over a short axial distance, thus obtaining a smaller footprint for the same slowdown (and therefore the same gain in efficiency of the exchanger).

The diffusion length necessary for a given area ratio (between the area of the section of the vein at the outlet of the diffusion channel and the area of the section at the inlet) is proportional to the height of the channel. Thus, by providing, for example, 5 adjacent corridors in height instead of a single channel, the diffusion is as stable as a single channel which would be 5 times longer axially.

The plurality of corridors according to the invention can for example comprise a number of corridors of between 2 and 10 corridors between two adjacent vanes.

The exchanger can be directly adjacent to the stator vanes, that is to say distant from the stator vanes by less than 5% of their axial length. The vanes and their fins therefore make it possible to guide the flow optimally for its flow in the exchanger.

The corridors are radially delimited externally and internally by fins, with the exception of the corridors at the radial ends (internal and external) of the air stream, which are delimited on one side (internal or external) by the casing.

According to an advantageous embodiment of the invention, the at least one fin is carried by the extrados of one vane of the two circumferentially adjacent vanes, and has a circumferential end cantilevered facing the intrados. on the other of the two vanes; or the at least one fin is carried by the intrados of one vane of the two circumferentially adjacent vanes, and has a circumferential end cantilevered facing the extrados of the other of the two vanes; or the at least one fin is carried by the intrados of one vane of the two circumferentially adjacent vanes and by the extrados of the other of the two vanes. Thus, the loss of aerodynamic pressure can be limited to the interfaces between the fin and the vanes.

According to an advantageous embodiment of the invention, the interface between the fin and the extrados, or between the fin and the intrados of the vane carrying it, is aerodynamically optimized, for example by a connection fillet.

According to an advantageous embodiment of the invention, each corridor is delimited radially internally and/or radially externally by two fins, one of which is carried by the extrados of a vane and the other is carried by the intrados. of a circumferentially adjacent vane, each of the two fins extending circumferentially over approximately half the circumferential distance between the two adjacent vanes.

According to an advantageous embodiment of the invention, each of the two fins has a free end, the free end of one fin being arranged in the vicinity of the free end of the other fin, the free ends being preferably tapered to be aerodynamically optimized.

It is understood that the design can be hybrid, that is to say that in the same annular row of stator vanes, certain fins can be provided on the intrados and/or others on the extrados. Thus certain vanes can carry a fin on their intrados, a fin on their extrados, or both.

According to an advantageous embodiment of the invention, the two circumferentially adjacent vanes as well as the at least one fin delimiting the corridor between these two vanes are in one piece. Thus, the loss of aerodynamic pressure can be minimal at the interfaces between the fin and the vanes. Several adjacent vanes and their fins can be in one piece and thus form an angular sector of the row of vanes.

“Monobloc” here is synonymous with “completely manufactured” or “come from material”.

According to an advantageous embodiment of the invention, structural arms are arranged at an axial position which at least partially overlaps that of the at least one exchanger, a vane of the annular row of vanes being aligned circumferentially with each structural arm, said vane preferably having a flared trailing profile. The structural arms (also called “struts”) extend substantially radially in the turbomachine and support the forces experienced by the structure. They are generally fewer and more massive than the vanes and generally have no aerodynamic role with respect to the flow passing through them. The complete or partial superposition of the arms and the exchanger makes it possible to further reduce the axial bulk of the turbomachine.

The flaring of the vane upstream of the structural arm results in its intrados moving away from its extrados and the vane does not really have a linear trailing “edge” but rather a surface edge. This makes it possible to properly direct the flow towards the strut which is circumferentially thicker than the vane, thus minimizing pressure losses in line with the exchanger and the struts.

According to an advantageous embodiment of the invention, the vanes are distributed angularly in an irregular manner, the vanes being more circumferentially spaced from each other in the angular portion(s) occupied by the exchanger(s). Thus, it is possible to better homogenize the distribution of air flow upstream of the vane (and downstream of the fan).

According to a variant, the leading edges of the vanes are distributed angularly regularly and the geometry of the vanes is such that the trailing edges are not distributed regularly angularly.

According to an advantageous embodiment of the invention, the annular row of vanes comprises vanes supporting one or more fin(s) and vanes without fins, the latter extending axially over a shorter length, preferably at at least twice or at least three times shorter than the first.

### BRIEF DESCRIPTION OF THE DRAWINGS

FIG. 1 is a sectional view of a turbomachine;

FIG. 2 represents a partial illustration of a secondary flow according to the state of the art;

FIG. 3 illustrates a partial view of a secondary flow according to the invention;

FIG. 4 shows an isometric view of a vane according to the invention;

FIG. 5 describes different variations of the fins;

FIG. 6 illustrates an embodiment with the structural arms;

FIG. 7 shows an additional variant of the invention;

FIG. 8 represents another variant of the invention;

FIG. 9 illustrates a variant of the invention.

### DETAILED DESCRIPTION

In the description which follows, the axial, circumferential and radial directions relate to the axis of rotation of the rotating parts of a turbomachine. Upstream and downstream relate to the direction of air flow through the turbomachine. The drawings are not shown to scale and some dimensions may be exaggerated for ease of understanding.

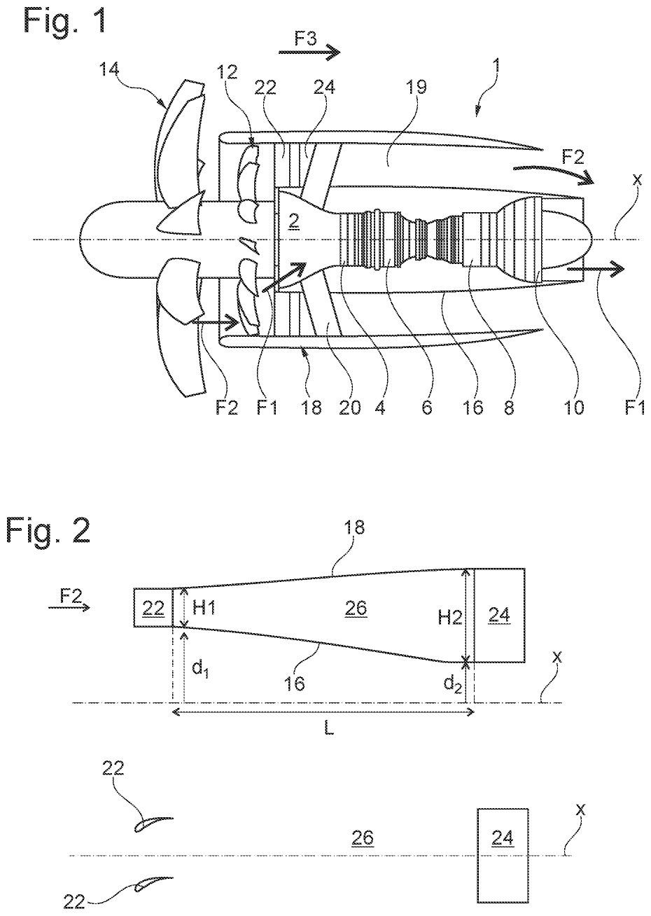

FIG. 1 shows a schematic sectional view of a turbomachine 1. An interior casing 2 guides a primary flow F1 which successively travels through compressors 4 (low and high pressure), a combustion chamber 6 and turbines 8 (high and low pressure), before escaping through a nozzle 10. The energy of the combustion drives the turbines 8 in rotation. The turbines 8 drive the compressors 4, directly via transmission shafts, or indirectly by means of reduction gears. The shafts are held in place by bearings which must be lubricated.

The turbines 8 also rotate a fan 12 which sets in motion a secondary flow F2. In accordance with the invention, the turbomachine 1 comprises a propeller 14 which propels a tertiary flow F3. Most of the thrust of the turbomachine is generated by the propulsion of the flow F3 by the propeller 14, which is called “propulsive”. Flow F2 is called “non-propulsive” and is allocated to additional functions (cooling). The primary flow F1 is used as an oxidant to ensure the rotation of the turbines and therefore of the fan 12 and the propeller 14.

A fairing 16 and a nacelle 18 delimit a passage 19 which is traversed by the secondary flow F2.

Structural arms 20 take up the forces between the nacelle 18 and the engine casing 2.

An annular row of stator vanes 22 (“outlet guide vanes”, OGV) can be arranged downstream of the fan 12 to straighten the flow F2.

The fan 12 and the propeller 14 can rotate in opposite directions to each other via a gear reducer (not shown). This reducer can also greatly reduce the rotation speed (between the turbines and fan/propeller).

Just like the bearings, the gearbox is lubricated. The oil circuit must evacuate the stored heat to maintain its lubricating properties and keep the components of the turbomachine in an optimal operating temperature range. A significant thermal energy must therefore be dissipated by the oil.

To do this, an air-oil exchanger 24 can be arranged in the secondary flow F2. The oil can be cooled by heat exchange with the abundantly available cold air.

FIG. 2 shows, at the top, a schematic view in axial section of a detail of the turbomachine of FIG. 1. This concerns the vanes 22 and the heat exchanger 24.

The exchanger 24 can be formed of a matrix defining corridors of fins through which the air passes and in thermal conduction with tubes through which the oil travels. An example is given in the EP document 3 696 389 A1.

In order to increase the efficiency of the heat exchanger 24, it may be useful to reduce the speed of the flow F2 before the flow reaches the exchanger 24. A known solution is to provide a diffusion channel 26. This can be part of the passage 19 and be delimited radially by the fairing 16 and the nacelle 18, or by additional fairing elements optimizing the desired geometry for the passage of the secondary flow F2 (not shown).

In order for the flow F2 to remain aerodynamically stable during its speed reduction, the axial length of the diffusion channel, denoted L, must be sufficient. This sufficient length is a function of H1, the radial height of the air stream receiving the flow F2 at the outlet of the vanes, as well as the ratio of the areas “seen by the flow” between the exchanger 24 and the vanes 22 (therefore function interior diameters d1, d2 and exterior diameters (d1+2*H1), (d2+2*H2) delimiting the fairing 16 and the nacelle 18).

A speed reduction of a factor of 2 to 5 can be expected, for example, from a Mach number of 0.4-0.5 to 0.1-0.2.

The bottom part of FIG. 2 shows a radial view of the vanes 22, the diffusion channel 26 and the exchanger 24.

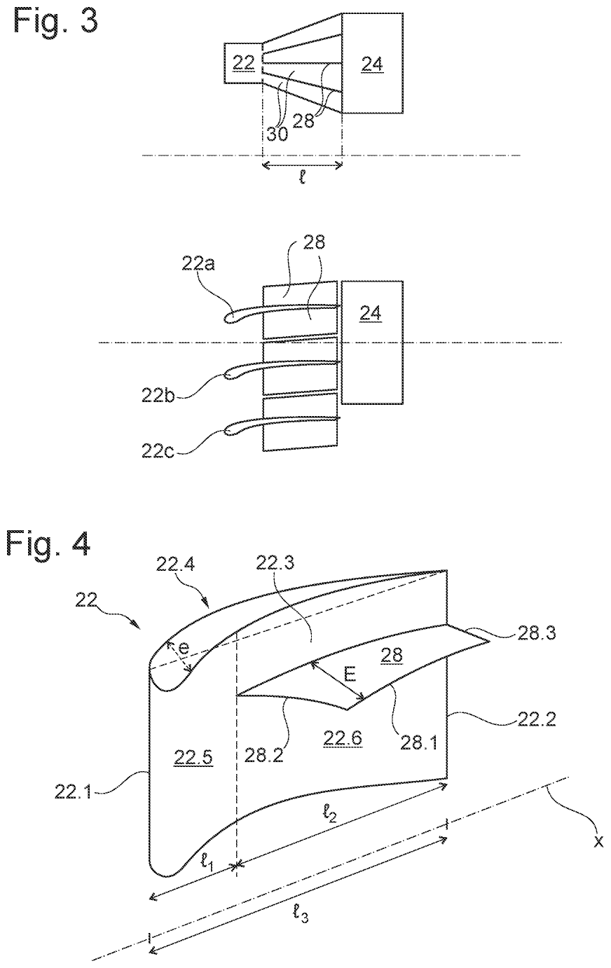

FIG. 3 represents a partial view of the secondary flow F2 in a turbomachine according to the invention.

A broadcast channel 26 is provided to slow down the flow F2. The channel 26 is subdivided by means of fins 28 into several corridors 30. The fins 28 can be carried by vanes 22 which extend axially into the diffusion channel 26. The length l of the diffusion channel 26 is inversely proportional to the number of corridors. Thus, l can be in this example four times smaller than L (annotated in FIG. 2).

The lower part of FIG. 3 shows a radial view. It can be seen in particular that the fins 28 can extend over more than the downstream half of the vanes 22, or even more than two thirds.

The vanes 22 which direct the flow towards the exchanger 24 are provided with fins 28. The other vanes (ie which are traversed by a flow which will not pass through the exchanger) can also be provided with fins. Alternatively, they may not include fins but be of the same length as those which support them. Alternatively, the vanes which do not direct the flow towards an exchanger are as short as those of the state of the art (see FIG. 2). Angularly in the annular row of vanes 22, a progressive variation in the length of the vanes can be provided, from the longest vanes preceding an exchanger, to the shortest vanes, angularly furthest from the exchanger.

FIG. 4 shows an isometric view of a vane 22 according to the invention. This vane 22 includes a leading edge 22.1, a trailing edge 22.2, an intrados 22.3 and an extrados 22.4.

The vane 22 comprises an upstream portion 22.5 of length 11 devoid of fin 28 and a downstream portion 22.6 of length 12 provided with one or more fins 28. The upstream part 22.5 can correspond to a vane geometry in itself with a trailing edge which extends axially, the entire downstream part 22.6 being formed of a vane extending such a trailing edge.

The fin(s) 28 may/can be supported by the extrados or the intrados, or both.

The total axial length of the vanes is l3=l1+l2. The length l1 of the upstream portion 22.5 represents between 10 and 50% of the total length of the vane l3. Preferably l1 is at least 25% of the length l3 of the vane and l2 is at least 2/3 of the length l3 of the vane.

The vane 22 has a maximum thickness e measured perpendicular to the chord.

When a fin 28 is cantilevered, ie supported by a single vane, it includes a free end 28.1 which determines the circumferential width E of the fin. Preferably E is much greater than e, for example at least 5 times greater.

Each fin 28 comprises an upstream edge 28.2 and a downstream edge 28.3.

The upstream edge 28.2 can be aerodynamically profiled like a leading edge. The downstream edge 28.3 can be aerodynamically profiled like a trailing edge.

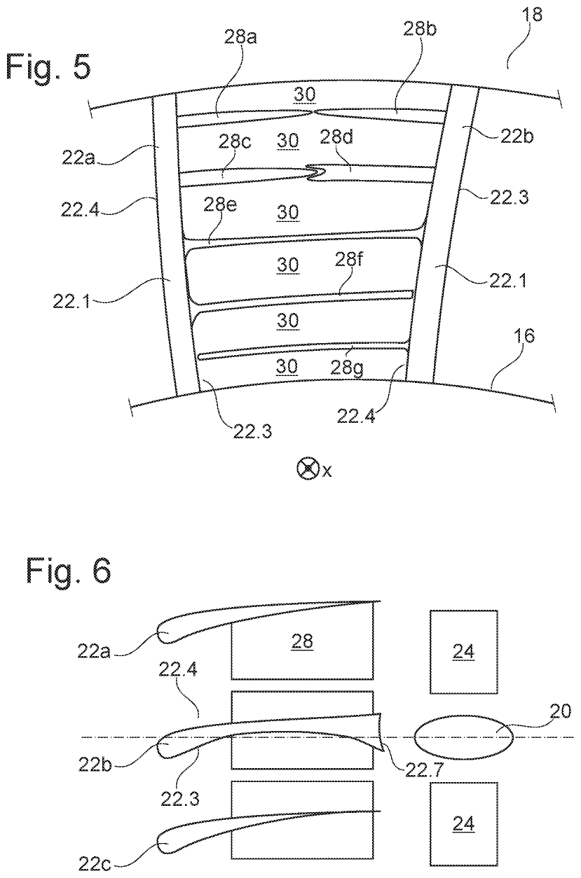

FIG. 5 brings together a certain number of possible embodiments for the fins 28 between two circumferentially adjacent vanes 22a and 22b. It is understood that all the fins 28 of the same annular row of vanes 22 can be of the same type or be of different types, and likewise all the fins 28 of the same inter-vane space can be identical or different. FIG. 5 brings together different examples.

Thus, the fins 28a and 28b extend from an intrados 22.3 and from an extrados 22.4, respectively. Their free ends meet approximately at the center of the inter-vane space. The same applies to fins 28c and 28d.

The fins 28a and 28b are tapered to facilitate the flow of flow at their free ends. The fins 28c and 28d have free ends with complementary profiles to minimize the gap between their ends.

The fin 28e is carried by the two adjacent vanes 22a, 22b. This illustrates that connection fillets can be provided in the vicinity of the vanes to minimize disturbances to the air flow. This may be the case for the other examples of fins 28 presented in FIG. 5.

Blades 28f and 28g show that fins can extend over the entire inter-vane space.

All of the vanes 22a, 22b and the fins 28 which extend from these vanes, as well as possibly an angular section of 16 and 18, can be in one piece. Optionally, several adjacent vanes and their fins can be in one piece, thus describing an angular sector of a few degrees of angles to a few tens of degrees (for example 12 sectors of 30° forming the annular row of vanes 22).

The fins 28 can have a concentric curvature with the axis of the turbomachine. The curvature in the plane of FIG. 5 can evolve along the axis to approximate the shape of the corridors of the exchanger 24. The corridors 30 of the diffusion channel can thus serve as a transition to properly prepare the flow for its passage in exchanger 24.

FIG. 5 represents six corridors 30 of substantially equivalent radial height, resulting from an equitable distribution of the fins between the root and the head of the vanes 22.

Alternatively, another distribution of the fins 28 is possible between the root and the head of the vanes 22. For example, the fins can be spaced further apart at the root of the vane and more tightened at the vane head to produce corridors 30 of section approximately equivalent and thus distribute the flow F2 into a number of corridors of equivalent volume.

FIG. 6 shows that in a preferred embodiment, the structural arms 20 can have the same axial position as (or be at least partially arranged overlapping) the heat exchanger 24.

In order to properly conduct the flow F2 upstream of the arm 20, the vane 22b which is circumferentially aligned with the arm 20 can have a suitable profile. In fact, the intrados 22.3 and the extrados 22.4 do not meet at a point (seen in the sectional profile perpendicular to the radius). The vane 22b is flared. A 22.7 trailing surface replaces the usual trailing edge.

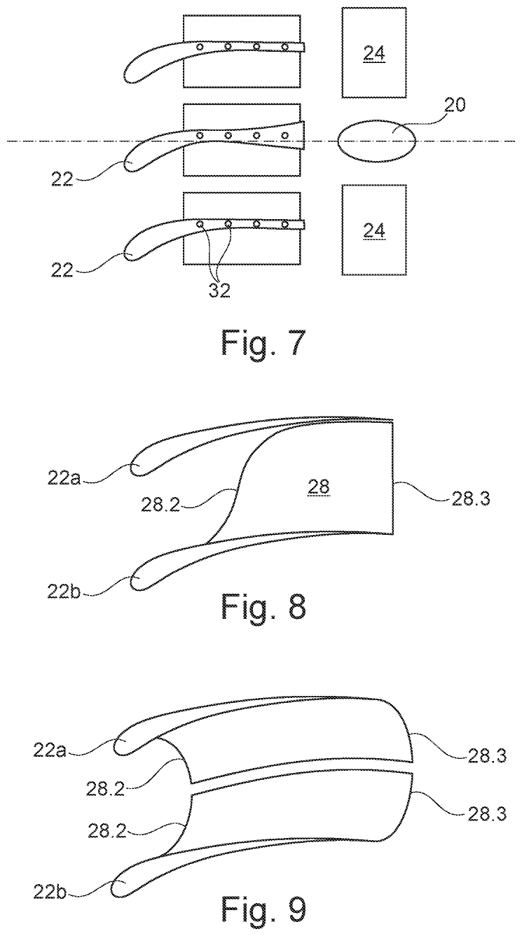

FIG. 7 shows an additional variation. The vanes 22 are here pierced with pipes 32 allowing the circulation of a fluid, in particular oil. Thus, the fins 28, whose primary purpose is to slow down the flow F2 for the exchanger 24, can also serve as a heat exchanger by cooling the fluid circulating in the pipes 32. The pipes 32 are preferentially circumscribed to the axial portion vanes 22 corresponding to fins 28 (downstream portion noted 22.6 in FIG. 4).

FIGS. 8 and 9 show a radial view of an inter-vane space. The fins 28 are described there with upstream edges 28.2 and/or downstream 28.3 which have a profile adapted to minimize disturbances to the flow F2. For example, in FIG. 8, the fin 28 extends from the extrados of the vane 22b only. The upstream edge 28.2 has a curvature with a point of inflection, roughly following the extrados of the vane 22b on the one hand and roughly following the intrados of the vane 22a on the other hand.

In FIG. 9, two fins 28 occupy the inter-vane space. The profile of the upstream edge 28.2 of the fins 28 is concave and the profile of the downstream edge 28.3 of the fins 28 is convex.

It is understood that each detail of each figure can be provided in combination with each detail of each other figure. For example, each of the types of fins presented in FIG. 5 can be used alone or in combination with one or more other types of fins, and each of these types of fins can be provided upstream of an arm structural (as in FIG. 6) or attached to a vane provided with pipes 32 (as in FIG. 7).

1. Turbomachine (1) for an aircraft comprising:
a compressor (4) compressing a primary flow (F1);
a fan (12) propelling a secondary flow (F2);
an annular passage (19) for the flow of the secondary flow (F2) downstream of the fan (12);
an unducted propeller (14) propelling a tertiary flow (F3), the primary (F1), secondary (F2) and tertiary (F3) flows being distinct from each other;
an annular row of guide vanes (22) arranged in the passage (19), each vane (22) having an intrados (22.3) and an extrados (22.4); and
at least one heat exchanger (24) arranged in the passage (19) downstream of the row of vanes (22);
turbomachine (1) characterized in that it further comprises:
a plurality of diffusion corridors (30) upstream of the at least one exchanger (24), each corridor (30) being delimited circumferentially by an intrados (22.3) and by an extrados (22.4) of two circumferentially adjacent vanes (22a, 22b), and each corridor (30) being delimited radially by at least one fin (28) carried by at least one of the two circumferentially adjacent vanes (22a, 22b).

2. Turbomachine (1) according to claim 1, characterized in that the at least one fin (28g) is carried by the extrados (22.4) of a vane (22) of the two circumferentially adjacent vanes (22a, 22b), and has a circumferential end (28.1) cantilevered facing the intrados (22.3) of the other of the two vanes (22).

3. Turbomachine (1) according to claim 1, characterized in that the at least one fin (28f) is carried by the intrados (22.3) of a blade (22) of the two circumferentially adjacent vanes (22a, 22b), and has a circumferential end (28.1) cantilevered facing the extrados (22.4) of the other of the two vanes (22).

4. Turbomachine (1) according to claim 1, characterized in that the at least one fin (28e) is carried by the intrados (22.3) of a vane (22) of the two circumferentially adjacent vanes and by the extrados (22.4) on the other of the two vanes (22a, 22b).

5. Turbomachine (1) according to one of claims 2 to 4, characterized in that the interface between the fin (28) and the extrados (22.4), or between the fin (28) and the intrados (22.3) of the vane (22) carrying it, is aerodynamically optimized, for example by a connection fillet.

6. Turbomachine (1) according to claim 1, characterized in that each corridor (30) is delimited radially internally and/or radially externally by two fins (28a, 28b, 28c, 28d), one of which is carried by the extrados (22.4) of a vane (22b) and the other is carried by the intrados (22.3) of a circumferentially adjacent vane (22a), each of the two fins (28) extending circumferentially over approximately half of the circumferential distance between the two adjacent vanes (22a, 22b).

7. Turbomachine (1) according to claim 6, characterized in that each of the two fins (28) has a free end (28.1), the free end (28.1) of a fin (28a, 28c) being arranged in the vicinity of the free end (28.1) of the other fin (28b, 28d), the free ends (28.1) being preferentially tapered to be aerodynamically optimized.

8. Turbomachine (1) according to one of the preceding claims, characterized in that the two circumferentially adjacent vanes (22a, 22b) as well as the at least one fin (28) delimiting the corridor (30) between these two vanes (22), are in one piece.

9. Turbomachine (1) according to one of the preceding claims, characterized in that structural arms (20) are arranged at an axial position which at least partially overlaps that of the at least one exchanger (24), a vane (22b) of the annular row of vanes (22) being circumferentially aligned with each structural arm (20), said vane (22b) preferably having a flared trailing profile.

10. Turbomachine (1) according to one of the preceding claims, characterized in that the vanes (22) are distributed angularly in an irregular manner, the vanes (22) being more spaced circumferentially from each other in the occupied angular portion(s) by the exchanger(s) (24).

11. Turbomachine (1) according to one of the preceding claims, characterized in that the annular row of vanes (22) comprises vanes (22) supporting one or more fin(s) (28) and vanes (22) devoid of fin (28), the latter extending axially over a length (11) shorter, preferably at least twice or at least three times shorter, than the first.
